(19) United States
(12) Patent Application Publication
(10) Pub. No.: US 2018/0364543 A1
(43) Pub. Date: Dec. 20, 2018

(54) INCREASED REFLECTANCE IN TOTAL INTERNAL REFLECTION-BASED IMAGE DISPLAYS

(71) Applicant: CLEARink Displays, Inc., Fremont, CA (US)

(72) Inventors: Lorne A. Whitehead, Vancouver (CA); Bram M. Sadlik, Vancouver (CA); Graham F. Beales, Vancouver (CA)

(73) Assignee: CLEARink Displays, Inc., Fremont, CA (US)

(21) Appl. No.: 15/781,810

(22) PCT Filed: Dec. 6, 2016
(86) PCT No.: PCT/US16/65068

§ 371 Date: Jun. 6, 2018

Related U.S. Application Data
(60) Provisional application No. 62/263,655, filed on Dec. 6, 2015.

(51) Int. Cl. G02F 1/19; G02F 1/167

(52) U.S. Cl. CPC G02F 1/19; G02F 1/167; B32B 2255/205; B32B 2551/00; B32B 2307/416; G02F 2203/023

(57) ABSTRACT

Brightness in conventional total internal reflection image displays may decrease due to incident light passing through the dark pupil region in the white state. Adding sub-wavelength structures to the surface of the convex protrusions on the transparent front sheet may increase brightness in the white state. Control of the size, spacing, shape and refractive index of the sub-wavelength structures may lead to zeroth order reflection and enhanced brightness.

The disclosure claims priority to the filing date of PCT Application No. PCT/US16/65068, filed Dec. 6, 2016, which claimed priority to U.S. Provisional Application No. 62/263,655, filed on Dec. 6, 2015, the specification of each of the applications is incorporated herein in its entirety.

### FIELD

This disclosure is directed to total internal reflection-based image displays. In one embodiment, the disclosure relates to increasing brightness in total internal reflection-based image displays by modifying the inward surface of the transparent high refractive index front sheet.

### BACKGROUND

Conventional total internal reflection (TIR) based displays comprise of a transparent high refractive index front sheet in contact with a low refractive index fluid. The front sheet and fluid have different refractive indices that are characterized by a critical angle. The front sheet is designed such that when light rays are incident upon the interface of the high refractive index front sheet and low refractive index fluid at angles less than the critical angle, they are transmitted through the interface. When light rays are incident upon the interface at angles greater than the critical angle they undergo TIR at the interface. A small critical angle (e.g., less than about 50°) is preferred at the TIR interface since this affords a larger range of angles over which TIR may occur.

Conventional TIR-based reflective image displays further comprise electrophoretically mobile, light absorbing particles. When particles are moved by a voltage bias source to the surface of the front sheet they enter the evanescent wave region and frustrate TIR. Incident light may be absorbed and creates a dark state observed by the viewer. When the particles are moved out of the evanescent wave region, light may be reflected by TIR. This creates a white or bright state that may be observed by the viewer. An array of pixelated electrodes may be used to drive the particles into and out of the evanescent wave region to form combinations of white and dark states. This may be used to create images to convey information to the viewer.

The front sheet in conventional TIR-based displays further comprises a plurality of close-packed convex structures on the inward side facing the low refractive index medium and electrophoretically mobile particles. The convex structures may be hemispherically-shaped but other shapes may be used. A prior art TIR-based display 100 is illustrated in FIG. 1. Display 100 comprises a transparent front sheet 102 further comprising a plurality of hemispherical protrusions 104, a rear support sheet 106, a transparent front electrode 108 on the surface of the hemispherical protrusions and a rear electrode 110. Within the cavity formed by the surface of hemispheres and the rear support sheet is a low refractive index fluid 112 further comprising a plurality of light absorbing electrophoretically mobile particles 114. Display 100 includes an optional voltage source 116 capable of creating a bias across the cavity. When particles 114 are electrophoretically moved near the front electrode 108, they may frustrate TIR. This is shown to the right of dotted line 118 and represented by incident light rays 120 and 122 being absorbed by the particles. The display is in the dark state as appears to viewer 124.

When particles are moved away from the front sheet 102 towards the rear electrode 110 as shown to the left of dotted line 118, incident light rays may be totally internally reflected at the interface of the surface of hemispherical array 104 and medium 112. This is represented by incident light ray 126, which is totally internally reflected and exits the display towards viewer 124 as reflected light ray 128. The display appears white or bright to the viewer.

It is well known that in the center of each hemisphere is a region where light rays may be transmitted and not undergo TIR. This is due to the reduced angles with which the incident light rays interact with the inward surface of the hemispheres. This non-reflective region presents a problem commonly referred to as the dark pupil problem. The dark pupil reduces the reflectance of the display. In FIG. 1, the dark pupil problem is illustrated by incident light ray 130 in display 100. The incident light ray 130 is not totally internally reflected. It is instead passed through front sheet 102 of the display which decreases the display brightness.

FIG. 2 is a cross sectional view of the TIR and dark pupil regions of a prior art front sheet in a TIR-based display. Specifically, front sheet 200 shows a portion of transparent sheet 202 having an outward surface 204 facing viewer 206 and a plurality of hemispheres 208 on its inward surface. Front sheet 200 further shows the approximate locations of the TIR region 210 and non-shadowed non-TIR region 212 (dark pupil region) for directly incident light rays on this region. These regions are located on the inward side of transparent sheet 202. Incident light rays that first interact in the TIR region 210 are totally internally reflected back towards viewer 206. Incident light rays that first interact in the non-TIR region 212 pass through the transparent sheet 202 and are not totally internally reflected. This region 212 may be referred to as the dark pupil region. Modifying the surface of the array of convex protrusions may diminish the dark pupil problem and increase brightness of the display.

### BRIEF DESCRIPTION OF DRAWINGS

These and other embodiments of the disclosure will be discussed with reference to the following exemplary and non-limiting illustrations, in which like elements are numbered similarly, and where:

FIG. 1 schematically illustrates a cross-section of a portion of a prior art TIR-based display;

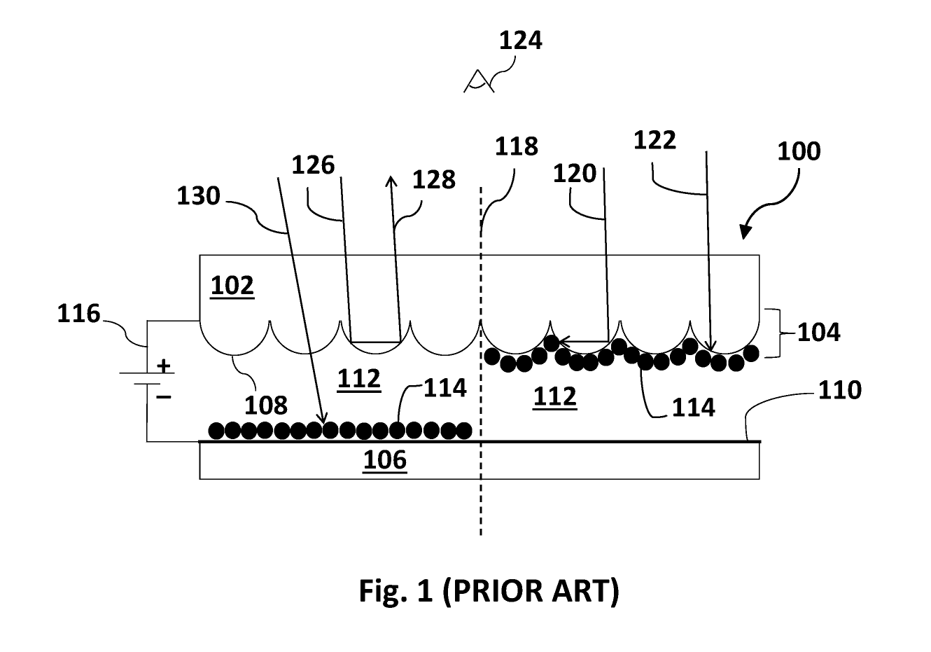

FIG. 2 is a cross sectional view of a conventional TIR showing dark pupil regions in a TIR-based display;

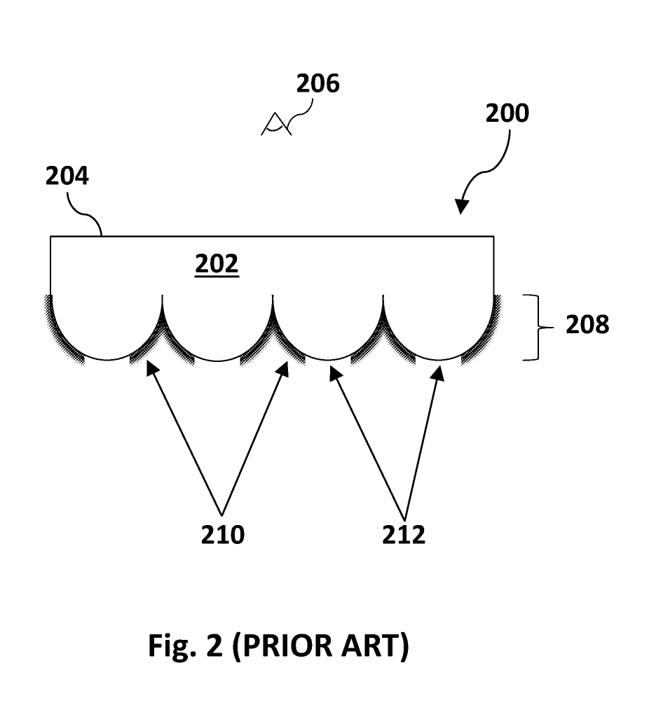

FIG. 3A schematically illustrates a cross-section of a portion of a front sheet of a TIR-based display according to one embodiment of the disclosure;

FIG. 3B schematically illustrates a view of the inward surface of a portion of a transparent front sheet of a TIR-based display according to one embodiment of the disclosure;

FIG. 4 schematically illustrates a top view of the inward surface of a portion of a transparent front sheet according to another embodiment of the disclosure;

FIG. 5A is a side view of an exemplary front sheet of a TIR display;

FIG. 5B schematically illustrates a top view of the inward surface of a portion of a transparent front sheet of FIG. 5A;

FIG. 6 schematically illustrates a top view of the inward surface of a portion of a transparent front sheet according to certain embodiments of the disclosure;

FIG. 7 schematically illustrates a top view of the inward surface of a portion of a transparent front sheet of a TIR-based display according to certain embodiments of the disclosure;

FIG. 8 schematically illustrates a view of the inward surface of a portion of a transparent front sheet of a TIR-based display according to certain embodiments of the disclosure;

FIG. 9 schematically illustrates a cross-section of a portion of a TIR-based image display with a modified surface at the dark pupil region;

FIG. 10 shows an exemplary system for controlling a display according to one embodiment of the disclosure;

FIG. 11 graphically illustrates the results of a first set of exemplary simulations; and

FIG. 12 graphically illustrates the results of a second set of exemplary simulations.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive sense.

In an exemplary embodiment, the inward surface of a transparent front sheet is configured to include a plurality of convex structures with a modified surface. The modified surface may increase the reflectance in a TIR-based image display. The surface may be modified to include a plurality of structures at the dark pupil region of the convex structures to address the deficiencies of the conventional displays and to prevent light rays from passing through the display.

In an exemplary embodiment, the modified surface may comprise sub-wavelength structures. The structures may include diffractive structures. The structures may be smaller than the wavelength of incident visible light. Sub-wavelength diffractive structures may be designed such that the structures behave substantially as reflectors. Sub-wavelength diffractive structures may be referred to as zeroth order mirrors. The index of refraction of the sub-wavelength structures may be substantially greater than the low index medium it contacts. The index of refraction of the sub-wavelength structures may be in the range of about 1.5-2.4 while the index of refraction of the medium may be in the range of about 1-1.5. The preferred geometries of the diffractive structures may depend on the index of refraction of the diffractive structures, the index of refraction of the adjacent material and the size and spacing of the diffractive structures. In an exemplary embodiment, light rays that would otherwise pass through the dark pupil region interacts with the zeroth order diffractive structure. A portion of that light may be reflected, thus increases the overall reflectance of the display.

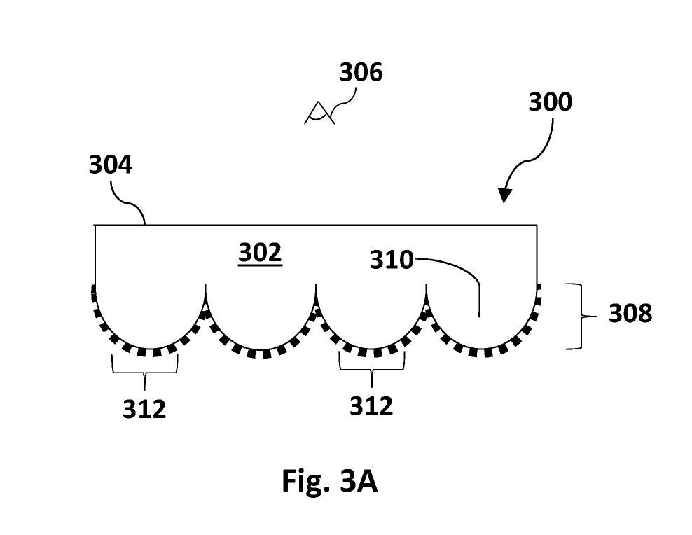

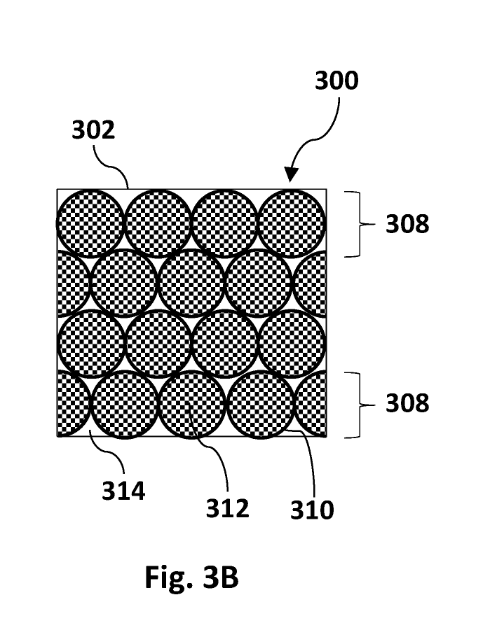

FIG. 3A schematically illustrates a cross-section of a portion of a front sheet of a TIR-based display front sheet according to one embodiment of the disclosure. Specifically, FIG. 3A shows convex protrusions with a modified surface. Embodiment 300 in FIG. 3A illustrates a transparent, high refractive index front sheet 302 further comprising an outward surface 304 facing viewer 306 and a plurality of convex protrusions 308. The refractive index of front sheet 302 may be at least about 1.5. In certain embodiments the refractive index of front sheet 302 may be in the range of about 1.5-2.4. Each individual protrusion 310 is hemispherical shaped but may assume other shapes or a mixture of shapes without departing from the disclosed principles. Other exemplary shapes include rectangular, hexagonal, diamond-like or triangular. Throughout this disclosure, hemispherical protrusions will be illustrated as the convex protrusions for simplicity. At least one convex protrusion may touch its nearest neighbor protrusion in a close-packed array. The curved surface of protrusions 308 may further include an array of transparent structures or features 312. In an exemplary embodiment, structures 312 may be sub-wavelength (i.e. smaller than the wavelength of incident visible light) in size and/or spacing. That is, each structure 312 may be sized (length and width) to be substantially equal or less than the wavelength of incident visible light.

Structures 312 may be arranged in a regular (i.e., periodic) or irregular array or a mixture of regular and irregular arrays. FIG. 3A shows an exemplary array that is checkerboard-like. Each structure 312 may be cubic or hexagonally-shaped. Structures 312 may also be in the form of spheres, hemisphere, hemi-cylinders, rectangular prisms, trigonal pyramids, square pyramids or other shapes. Structures 312 may comprise random shapes. Structures 312 may comprise random sizes or random spacing distances or both random sizes and spacing distances. Structures 312 may comprise a different composition than the convex protrusions 308. Structures 312 may have a refractive index that is not the same as the refractive index of the convex protrusions 308.

FIG. 3B schematically illustrates a view of the inward surface of a portion of a transparent front sheet of a TIR-based display according to one embodiment of the disclosure. Here, the front sheet embodiment 300 of a TIR-based display includes convex protrusions with modified surfaces. Transparent sheet 302 in FIG. 3B is a top view of the front sheet of a display shown in FIG. 3A. FIG. 3A is a cross-sectional view while FIG. 3B is a view directly at the array of protrusions on the inward surface of the transparent, high refractive index front sheet 302. Front sheet embodiment 300 in FIG. 3B further shows convex protrusions 310 in arrays 308, the modified surface with sub-wavelength structures 312 and the interstitial spaces 314 between the closely packed protrusions 310. In this embodiment, the sub-wavelength structures 312 are located on the curved surfaces of the individual convex protrusions 312.

In an exemplary embodiment, front sheet 302 includes a transparent electrode layer on the inward side on the surface of the convex protrusions. The transparent electrode may be one or more of indium tin oxide (ITO), an electrically conducting polymer or metallic nanoparticles such as aluminum in a clear polymer matrix.

In an exemplary embodiment, front sheet 302 may comprise a transparent electrode layer and a dielectric layer on the inward side on the surface of the convex protrusions. The dielectric layer may be located over the transparent front electrode layer and face the rear electrode. The dielectric layer can be used to protect the transparent electrode layer. The dielectric layer may define a conformal coating and may be free of pin holes or may have minimal pin holes. The dielectric layer may also be a structured layer. The dielectric layer may be a polymer or a combination of polymers. In an exemplary embodiment, the dielectric layer may include parylene. The dielectric layer may be a polymer such as a halogenated parylene or a polyimide. The dielectric layer may be a glass such as SiO₂ or other metal oxide inorganic layer. The dielectric layer may be a combination of a polymer and a glass.

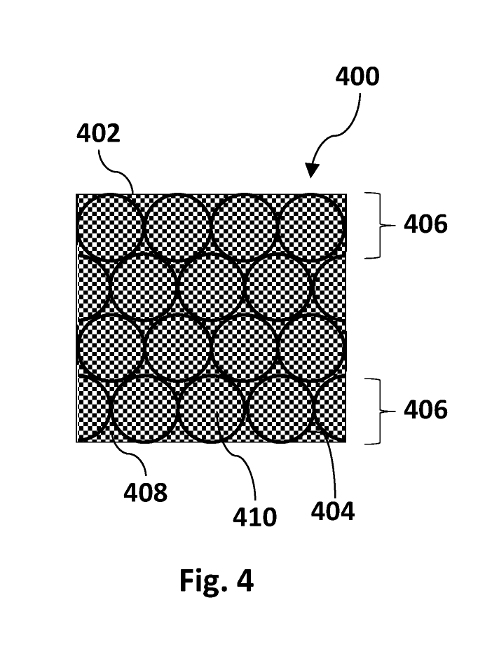

FIG. 4 schematically illustrates a top view of the inward surface of a portion of a transparent front sheet according to another embodiment of the disclosure. Front sheet embodiment 400 is shown with a transparent, high refractive index front sheet 402 and individual convex protrusions 404. At least one protrusion may be located on the inward surface in a close-packed array 406. The convex protrusions may be in a random array. Substantially flat interstitial spaces 408 may exist between the convex protrusions 404. The curved surface of the convex protrusions 404 and flat interstitial spaces 408 may comprise sub-wavelength structures 410. In an exemplary embodiment, structures 410 may be smaller in size and spacing than the wavelength of incident light.

In another exemplary embodiment, front sheet 402 may comprise a transparent electrode layer (not shown) on the inward side on the surface of the convex protrusions. In still another exemplary embodiment, front sheet 402 may comprise a transparent electrode layer (not shown) and a dielectric layer (not shown) on the inward side on the surface of the convex protrusions.

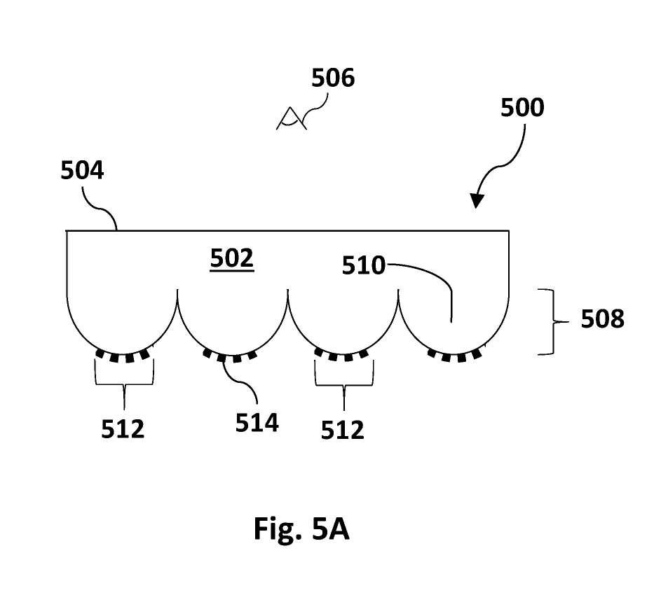

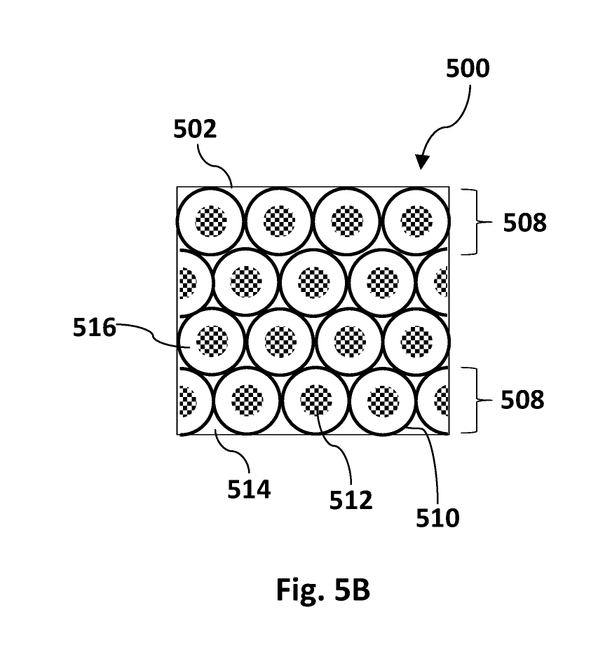

FIG. 5A is a side view of an exemplary front sheet of a TIR display. Specifically, FIG. 5A shows a cross-section of a portion of a transparent front sheet of a TIR display with convex protrusions having a modified surface at its dark pupil region. In front sheet embodiment 500, only the dark pupil regions include sub-wavelength structures. The remaining portions of the convex protrusions do not include sub-wavelength structures. Front sheet embodiment 500 comprises a transparent, high refractive index front sheet 502, outward surface 504 facing viewer 506 and a plurality of convex protrusions 508. In one implementation, some or all of the convex protrusions 510 may at least touch a neighboring convex protrusion. The curved surface of each of the convex protrusions 510 may further comprise a plurality of transparent structures or features 512 on the dark pupil region.

In the exemplary embodiment of FIG. 5, structures 514 can be sub-wavelength (i.e. smaller than the wavelength of incident light) in size and spacing. The individual structures 514 may be in the form of squares or cubes. Structures 514 may also be in the form of one or more of spheres, hemisphere, hemi-cylinders, rectangular prisms, trigonal pyramids, square pyramids or other shapes. In one embodiment, structures 514 may comprise random shapes.

It should be noted that the dark pupil region may change based on the viewing and illumination angles. In the front sheet embodiment of FIG. 5A, structures 512 may be located in the region where the dark pupil region may exist based on typical viewing and illumination angles. Typical viewing angles may be in the range from about −30° to about 30° relative to the normal angle (the normal angle is 0° when a viewer views the front surface of the display in a perpendicular direction). Typical illumination angles are in the range of about −5° to about −30° and about 5° to about 30° relative to the normal angle. In other embodiments, structures 512 may be located on other regions of the surface of the convex protrusions based on the application of the display.

FIG. 5B schematically illustrates a top view of the inward surface of a portion of a transparent front sheet of FIG. 5A. The embodiment 500 of FIG. 5B includes convex protrusions 510 in close-packed arrays 508. Front sheet embodiment 500 includes modified surfaces 512 of the dark pupil region of the convex protrusions 510 with sub-wavelength structures and interstitial spaces 514 between the closely packed protrusions 510. The convex protrusions may also be arranged in random arrays. In this embodiment, sub-wavelength structures 512 may only be located on the curved surfaces of the individual convex protrusions 510 in the dark pupil regions. Some regions 516 of the curved surfaces of the convex protrusions 510 may not be covered with sub-wavelength structures 512.

In an exemplary embodiment, front sheet 502 may comprise one or more of a transparent electrode layer and dielectric layer on the inward side on the surface of the convex protrusions.

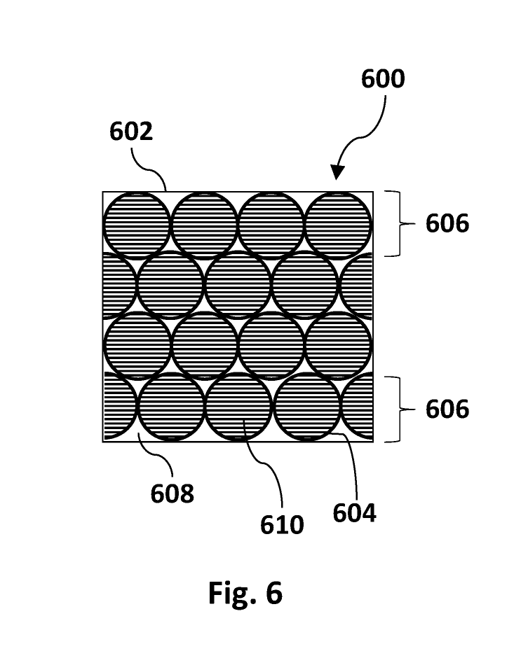

FIG. 6 schematically illustrates a top view of the inward surface of a transparent front sheet according to one embodiment of the disclosure. Specifically, the front sheet embodiment of a TIR-based display of FIG. 6 includes convex protrusions with a modified surface. Embodiment 600 of a transparent front sheet for a TIR-based reflective image display is similar to embodiment 300 in FIG. 3B except the transparent sub-wavelength structures may be diffraction lines or ridges. A diffraction line may be a contiguous line that extend along a length of the convex protrusion. Front sheet embodiment 600 includes a transparent, high refractive index front sheet 602 with convex protrusions 604. At least one protrusion 604 may be arranged in close-packed arrays 606 or random arrays with interstitial spaces 608 in between. The curved surfaces of the convex protrusions 604 may comprise transparent diffraction ridges 610. Ridges 610 may be spaced at sub-wavelengths to the incident light. Ridges 610 may be in the form of elongated trigonal pyramids or square pyramids.

In an exemplary embodiment, front sheet 602 may comprise a transparent electrode layer on the inward side on the surface of the convex protrusions. In an exemplary embodiment, front sheet 602 may comprise a transparent electrode layer and a dielectric layer on the inward side on the surface of the convex protrusions.

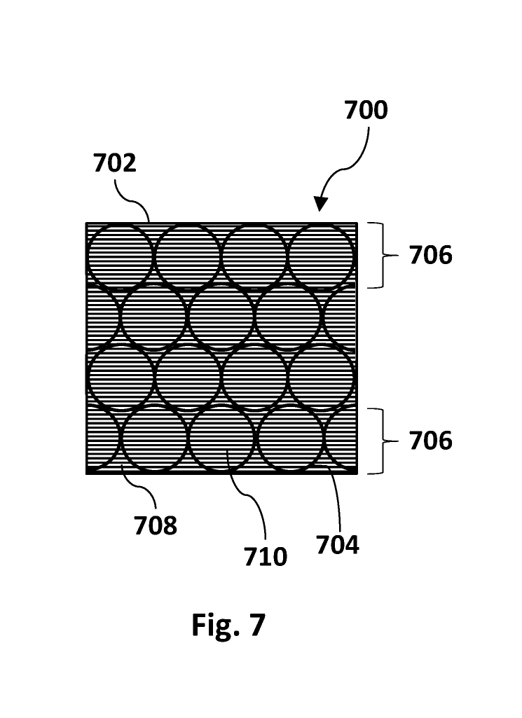

FIG. 7 schematically illustrates a top view of the inward surface of a transparent front sheet according to another embodiment of the disclosure. The front sheet embodiment of FIG. 7 includes convex protrusions with a modified surface. Transparent front sheet embodiment 700 for a TIR-based reflective image display is similar to embodiment 400 in FIG. 4 except the sub-wavelength structures are diffraction lines or ridges. Such ridges may extend the length of the protrusions. Front sheet embodiment 700 includes a transparent, high refractive index front sheet 702 with convex protrusions 704. At least one protrusion 704 may be arranged in a close-packed array 706 or in a random array with flat interstitial spaces 708 in between. The curved surfaces of the convex protrusions 704 and flat interstitial spaces may comprise transparent diffraction ridges 710. Ridges 710 may be spaced at sub-wavelengths to the incident light. Ridges 710 may be in the form of one or more of elongated trigonal pyramids, square pyramids, half cylinders or other shapes.

In an exemplary embodiment, front sheet 702 may comprise a transparent electrode layer on the inward side on the surface of the hemispherical protrusions. In an exemplary embodiment, front sheet 702 may comprise a transparent electrode layer and a dielectric layer on the inward side of the surface of the convex protrusions. As evident from FIG. 7, the ridges continue beyond protrusions 704 into interstitial spaces 708.

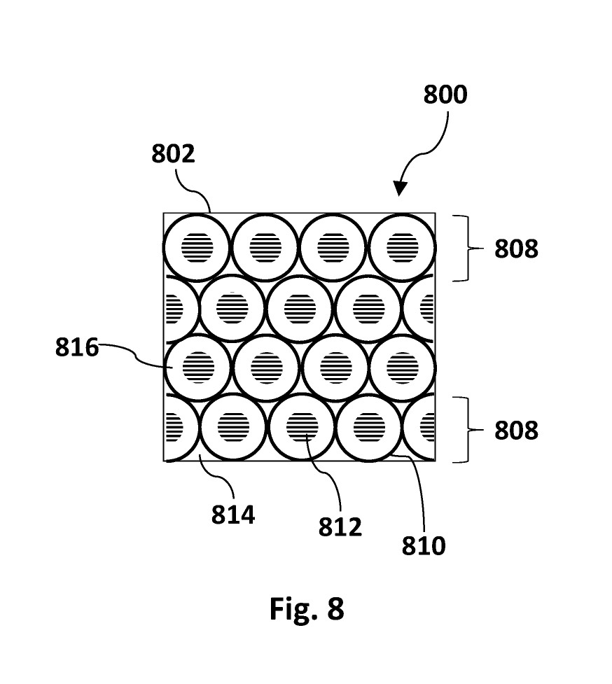

FIG. 8 schematically illustrates a top view of the inward surface of a portion of a transparent front sheet. The illustrated embodiment can define a portion of a front sheet of a TIR-based display with convex protrusions having a modified surface at the dark pupil region. Front sheet embodiment 800 of FIG. 8 is substantially similar to the embodiment shown in FIG. 5B except the sub-wavelength structures are diffraction lines or ridges. Front sheet embodiment 800 may comprise a transparent high refractive index sheet 802 and at least one convex protrusion 810 in a close-packed array 808 or in a random array. There may be interstitial spaces 814 between the convex protrusions 810. Front sheet embodiment 800 of FIG. 8 may also include modified surfaces 812 of the dark pupil region of the convex protrusions 810 with sub-wavelength structures. In this embodiment, the sub-wavelength structures 812 may only be located on the curved surfaces of the individual convex protrusions 810 in the dark pupil regions. Regions 816 of the curved surfaces of the convex protrusions 810 may not be covered with sub-wavelength structures 812.

Front sheet 802 may comprise one or more of a transparent electrode layer and a dielectric layer on the inward side on the surface of the convex protrusions.

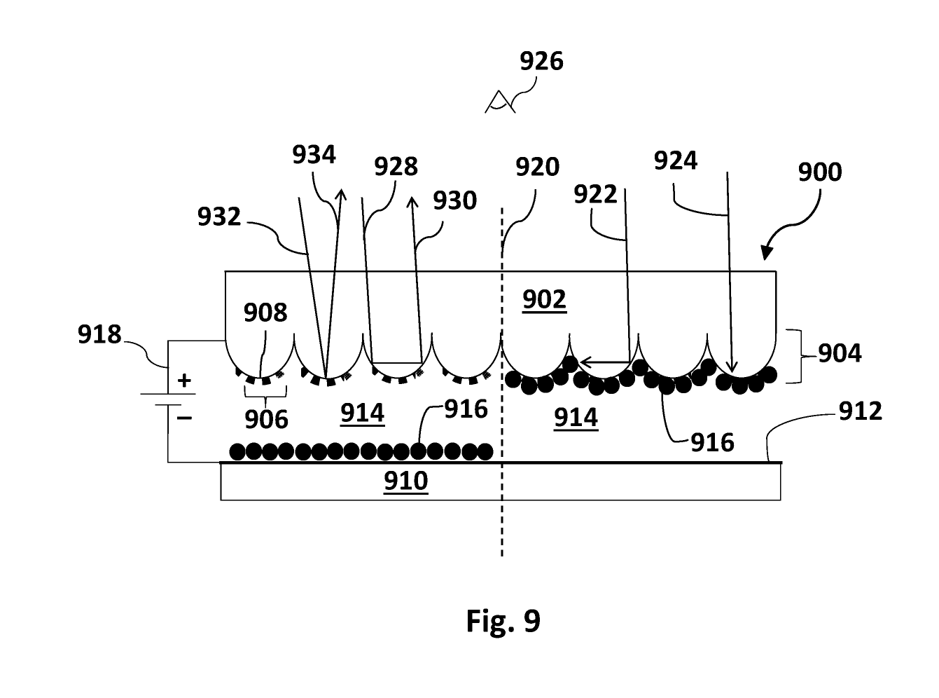

FIG. 9 schematically illustrates a cross-section of a portion of a TIR-based image display according to one embodiment of the disclosure. Display 900 includes transparent front sheet 902 having a plurality of convex protrusions 904. On the surface of the convex protrusions at the dark pupil region can be sub-wavelength structures 906. In one embodiment, structures 906 are larger than the incident wavelength. Front sheet 902 is substantially similar to the embodiment 500 of FIGS. 5A-B. Display 900 is also shown with transparent front electrode 908 on the surface of convex protrusions 904. Front electrode 908 may comprise ITO, an electrically conducting polymer or conductive metallic nanoparticles dispersed in a clear polymer matrix.

Display 900 further comprises a rear support sheet 910 and a rear electrode layer 912 on the rear support sheet 910. In an exemplary embodiment, rear electrode layer 912 may be a thin film transistor (TFT) array. In other embodiments the rear electrode layer 912 may be a patterned direct drive array or electrodes or a passive matrix array of electrodes.

As illustrated in FIG. 9, a gap or cavity is formed between rear electrode 912 and the outer surface of the convex protrusions (i.e., front electrode 908 and any dielectric layer formed thereon). A medium 914 may be disposed in the gap. Medium 914 may be air or a fluid or any material having a low refractive index in the range of about 1-1.5. In an exemplary embodiment, medium 914 may be a hydrocarbon, a halogenated hydrocarbon such as a fluorinated hydrocarbon or a combination thereof.

Display 900 further comprises a plurality of light absorbing electrophoretically mobile particles 916 dispersed in medium 914. Particles 916 may have a positive polarity or a negative polarity. Particles 916 may be a pigment or a dye. Particles 916 may be carbon black or a metal oxide-based pigment. Particles 916 may comprise an organic layer. Particles 916 may be of any color.

In an exemplary embodiment, display 900 comprises an optional voltage source 918 capable of creating a bias across medium 914. The bias may be able to move at least one of particles 916. While not shown, voltage source 918 may be coupled to one or more processor circuitry and memory processor configured to change or switch the applied bias in a predefined manner. For example, the processing circuity may switch the applied bias to display characters on display 900.

In an exemplary embodiment, display 900 may further comprise at least one dielectric layer (not shown). A dielectric layer may be located on the surface of the front electrode or on the rear electrode or on both the front and rear electrodes.

Display 900 may be operated as follows. When particles 916 are electrophoretically moved near the front electrode 908 by application of a bias of opposite polarity of the particles, they may enter the evanescent wave region and frustrate TIR. This is shown to the right of dotted line 920. Representative incident light rays 922 and 924 may be absorbed by particles 916. The display is in the dark state as appears to viewer 926.

Particles 916 may be moved away from the front electrode 908 and out of the evanescent wave region towards the rear electrode 912 as shown to the left of dotted line 920. Incident light rays may be totally internally reflected at the interface of the surface of the array of convex protrusions 904 and medium 914. This may be represented by incident light ray 928. Light ray 928 may be totally internally reflected and exit the display towards viewer 926 as reflected light ray 930. Other incident light rays may undergo zeroth order reflection that may otherwise pass through the dark pupil region. This is represented by incident light ray 932 that is zeroth order reflected as light ray 934 towards viewer 926. The display appears white or bright to viewer 926.

Display 900 may be used with any front sheet as discussed above, for example, with any of the exemplary front sheets described in FIGS. 3-8. Particles 916 and medium 914 in display 900 may be replaced by an electrofluidic system (may also be referred to as an electrowetting system). The electrofluidic system may be used to modulate the light absorption and reflection instead of electrophoretically mobile particles 916. The electrofluidic system may comprise a polar fluid and a non-polar fluid. The fluids may comprise a negative or positive polarity or charge. In an exemplary embodiment, one fluid may comprise a color while the other fluid may be transparent. In an exemplary embodiment the transparent fluid may have a low refractive index in the range of about 1-1.5. The transparent fluid may comprise a hydrocarbon or a halogenated hydrocarbon. In other embodiments both fluids may comprise a color. The non-polar fluid may comprise silicon oil, alkane oil, solvent mixture of silicon oil or solvent mixture of alkane oil. In some embodiments the difference between the refractive index of the polar fluid and the refractive index of the non-polar fluid may be in the range of about 0.05 to about 1.5. A bias may be applied at the front electrode 908 of display 900 of opposite charge as the charge of the colored fluid. The colored fluid may then be attracted to the front electrode 908. In this position the colored fluid may absorb incident light creating a dark state. If a bias of opposite polarity of the colored fluid is applied at the rear electrode layer 912, the colored fluid may be attracted to rear electrode 912. Incident light rays may be reflected towards viewer 926 by total internal reflection creating a bright state of the display.

In other embodiments, any of the reflective image displays comprising a front sheet with an array of convex protrusions with sub-wavelength structures may further include at least one spacer structure. The spacer structures may be used to control the gap between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, plastic or other resin.

In other embodiments, the image display may further include a color filter layer. The color filter layer may be located on the outward surface of the transparent front sheet. The color filter layer may include, among others, red, green and blue filters or cyan, magenta and yellow filters.

In still other embodiments, the image display may further include at least one edge seal. The edge seal may be a thermally or photo-chemically cured material. The edge seal may comprise one or more of an epoxy, silicone or other polymer based material.

In other embodiments, the image display may further include at least one sidewall (may also be referred to as cross-walls). The sidewalls limit particle settling, drift and diffusion to improve display performance and bistability. The sidewalls may be located within the light modulation layer comprising the particles and medium. The sidewalls may completely or partially extend from the front electrode, rear electrode or both the front and rear electrodes. The sidewalls may comprise plastic, metal or glass or a combination thereof. The sidewalls may create wells or compartments (not shown) to confine the electrophoretically mobile particles. The sidewalls or cross-walls may be configured to create wells or compartments in, for example, square-like, triangular, pentagonal or hexagonal shapes or a combination thereof. The side walls may comprise a polymeric material and patterned by conventional techniques including photolithography, embossing or molding. The walls help confine the mobile particles to prevent settling and migration of said particles that may lead to poor display performance over time. In certain embodiments the displays may include cross-walls that completely bridge the gap created by the front and rear electrodes in the region where the air or liquid medium and the electrophoretically mobile particles reside. In certain other embodiments, the reflective image display described herein may comprise partial cross-walls that only partially bridge the gap created by the front and rear electrodes in the region where the air or liquid medium and the mobile particles reside. In certain embodiments, the reflective image display may further include a combination of cross-walls and partial cross-walls that may completely and partially bridge the gap created by the front and rear electrodes in the region where the medium and the electrophoretically mobile particles reside.

A directional front light may be employed with the disclosed display embodiments. The directional front light system may include a light source, light guide and an array of light extractor elements on the outward surface of the front sheet in each display. The directional light system may be positioned between the outward surface of the front sheet and the viewer. The front light source may define a light emitting diode (LED), cold cathode fluorescent lamp (CCFL) or a surface mount technology (SMT) incandescent lamp. The light guide may be configured to direct light to the front entire surface of the transparent outer sheet while the light extractor elements direct the light in a perpendicular direction within a narrow angle, for example, centered about a 30° cone, towards the front sheet. A directional front light system may be used in combination with cross-walls or a color filter layer in the display architectures described herein or a combination thereof.

In some embodiments, a light diffusive layer may be employed with the disclosed display embodiments. In other embodiments, a light diffusive layer may be used in combination with a front light.

In some embodiments, a porous reflective layer may be used in combination with the disclosed display embodiments. The porous reflective layer may be interposed between the front and rear electrode layers. In other embodiments the rear electrode may be located on the surface of the porous electrode layer.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments the tangible machine-readable non-transitory storage medium may be further used in combination with one or more processors.

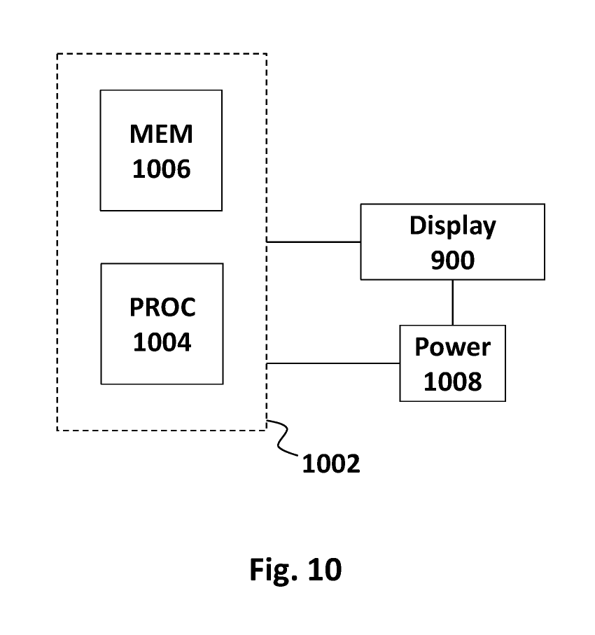

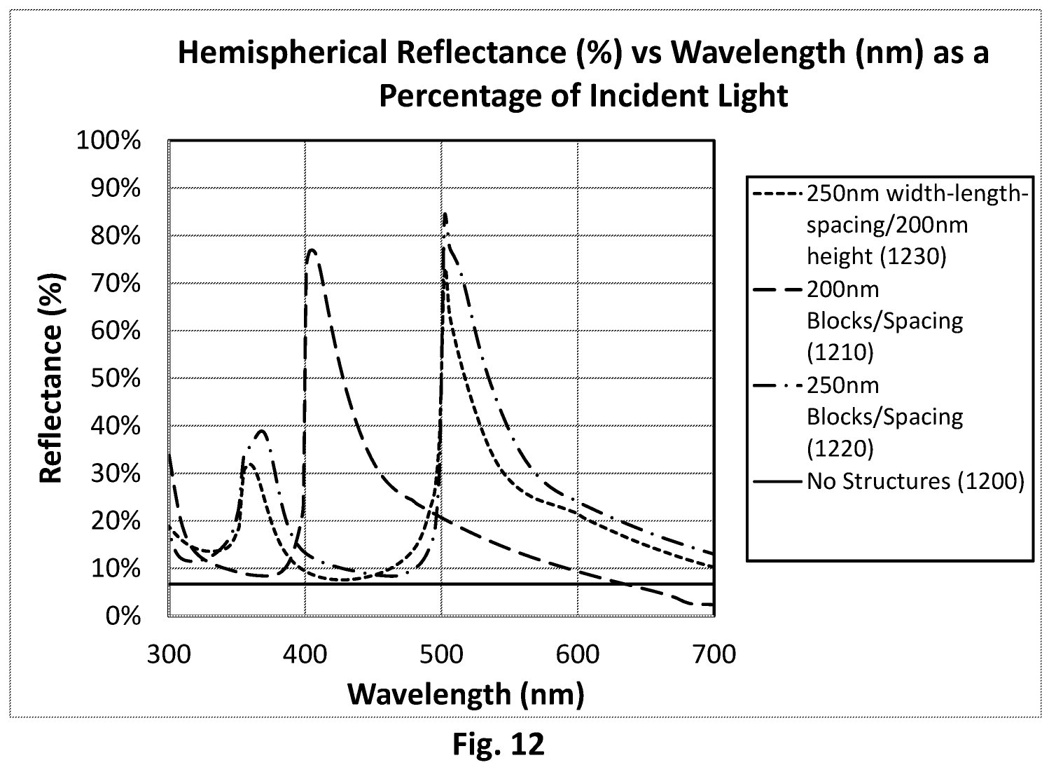

FIG. 10 shows an exemplary system for controlling a display according to one embodiment of the disclosure. In FIG. 12, display 900 is controlled by controller 1002 having processor 1004 and memory 1006. Other control mechanisms and/or devices may be included in controller 1002 without departing from the disclosed principles. Controller 1002 may define hardware, software or a combination of hardware and software. For example, controller 1002 may define a processor programmed with instructions (e.g., firmware). Processor 1004 may be an actual processor or a virtual processor. Similarly, memory 1006 may be actual memory (i.e., hardware) or virtual memory (i.e., software).

Memory 1006 may store instructions to be executed by processor 1004 for driving display 900. The instructions may be configured to operate display 900. In one embodiment, the instructions may include biasing electrodes associated with display 900 (not shown) through power supply 1008. When biased, the electrodes may cause movement of electrophoretic particles to a region proximal to the front electrode to thereby absorb light. Absorbing the incoming light creates a dark state of display 900. By appropriately biasing the electrodes, mobile light absorbing particles (e.g., particles 916, FIG. 9) may be summoned to a location away from the transparent front electrode (e.g., electrode 908, FIG. 9) and out of the evanescent wave region. Moving particles out of the evanescent wave region causes light to be reflected at the surface of the plurality of convex protrusions (e.g., protrusions 904, FIG. 9) by TIR and zeroth order reflections. Reflecting the incoming light creates a light state of display 900.

The exemplary displays disclosed herein may be used as electronic book readers, portable computers, tablet computers, cellular telephones, smart cards, signs, watches, wearables, shelf labels, flash drives and outdoor billboards or outdoor signs comprising a display.

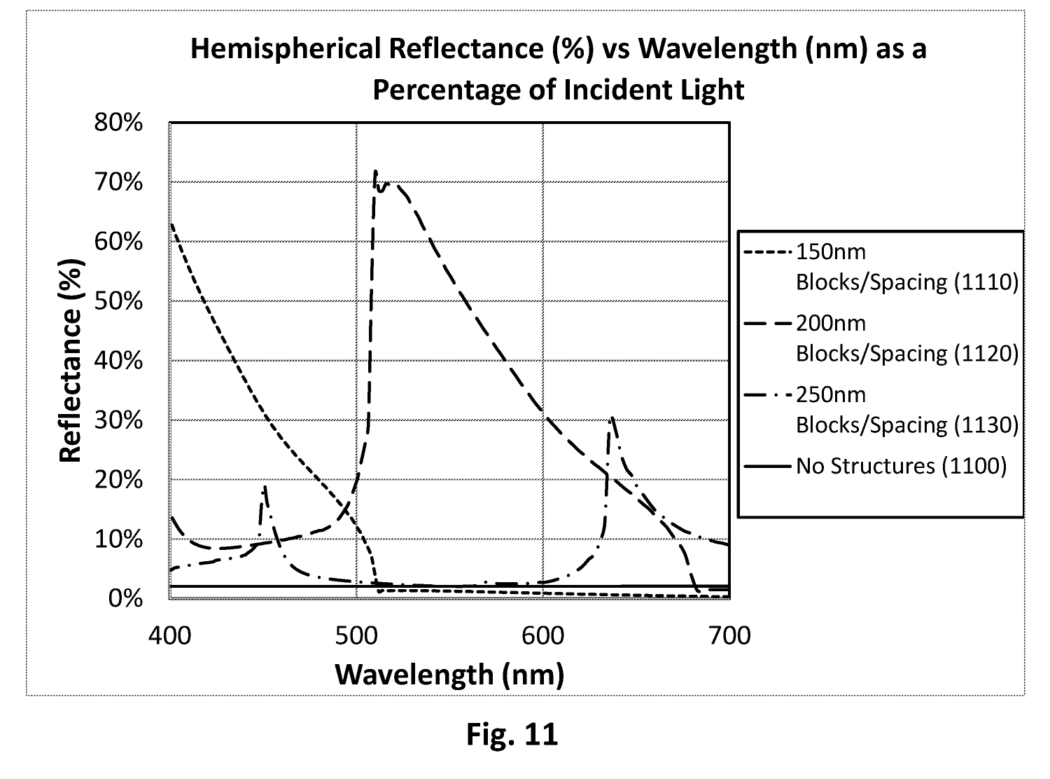

FIG. 11 graphically illustrates the results of a first set of simulations. To support and illustrate the embodiments described herein, simulations of modeled systems have been carried out using Lumerical Finite Difference Time Domain (FDTD) Solutions software (Release 2016B, Version 8.16). In the first simulation 1100, the model includes collimated light that is incident in a perpendicular direction to an interface of a planar glass substrate with refractive index of 1.7 in contact with a medium of refractive index of 1.27. The graph in FIG. 11 shows the hemispherical reflection as a function of the wavelength (nanometers) as a percentage of the incident light. In the graph in FIG. 11, the planar glass sheet with no structures reflects about 2.1% light across all wavelengths from about 400 nm to about 700 nm. This is represented by the solid line in FIG. 11.

In a second simulated system 1110, the glass substrate with refractive index of 1.7 further comprises block-shaped nanometer-sized structures with refractive indices of 2.2 on the opposite side of the interface from the incident light. A medium with refractive index of 1.27 is in contact on one side of the glass substrate comprising the nanometer sized structures. The nanostructures have equal height, length and width of 150 nm. The structures are also spaced 150 nm apart in a checkerboard-like fashion. The resulting reflectance data is shown by dotted line 1110 in FIG. 11. The 150 nm structures reflect light that has a wavelength of about 400 nm to about the 500 nm.

In a third simulated system 1120, the nanostructures are also in the shape of blocks as in system 1110 but with equal height, length and width of 200 nm. They are also spaced apart by 200 nm in a checkerboard-like fashion. They are also in contact with a medium with a refractive index of about 1.27. Structures of these dimensions increases the reflectance of light in the 400 nm to 700 nm range but mostly in the 500 nm to about 650 nm range when compared to system 1100 that is absent of the nanostructures. The resulting reflectance data is shown by dashed line 1120 in FIG. 11.

In a fourth simulated system 1130, the nanostructures are also in the shape of blocks as in systems 1110 and 1120 but with equal height, length and width of 250 nm. They are also spaced apart by 250 nm in a checkerboard-like fashion. They are also in contact with a medium with a refractive index of about 1.27. Structures of these dimensions increases the reflectance in about the 400-480 nm range and in the 620-700 nm range when compared to system 1100 that is absent of the nanostructures. The resulting reflectance data is shown by dot-dashed line 1130 in FIG. 11.

FIG. 12 graphically illustrates the results of a second set of simulations. In the first simulation 1200 in FIG. 12, the model includes collimated light that is incident in a perpendicular direction to an interface of a planar glass substrate with refractive index of 1.7 in contact on one side with a medium of refractive index of 1. The graph in FIG. 12 illustrates the hemispherical reflection as a function of the wavelength (nanometers) as a percentage of the incident light. In the graph in FIG. 12, the planar glass sheet with no structures reflects about 6.7% light across all wavelengths from about 300 nm to about 700 nm. This is represented by the solid line 1200 in FIG. 12.

In a second simulated system 1210 in FIG. 12, the glass substrate with refractive index of 1.7 further comprises block-shaped nanometer-sized structures with refractive indices of also 1.7 on the opposite side of the interface from the incident light. A medium with refractive index of 1 is in contact on one side of the glass substrate comprising the nanometer sized structures. The nanostructures have equal height, length and width of 200 nm. The structures are also spaced 200 nm apart in a checkerboard-like fashion. The resulting reflectance data is shown by dashed line 1210 in FIG. 12. The 200 nm structures 1210 increase the % reflectance when compared to the glass with no structures 1200 in the range of wavelengths of about 400 nm to about the 600 nm.

In a third simulated system 1220 in FIG. 12, the glass substrate with refractive index of 1.7 further comprises block-shaped nanometer-sized structures with refractive indices of also 1.7 on the opposite side of the interface from the incident light. A medium with refractive index of 1 is in contact on one side of the glass substrate comprising the nanometer sized structures. The nanostructures are similar to structures 1210 but have equal height, length and width of 250 nm. The structures are also spaced 250 nm apart in a checkerboard-like fashion. The resulting reflectance data is shown by dot-dashed line 1220 in FIG. 12. The 250 nm structures 1220 increase the % reflectance when compared to the glass with no structures 1200 in the range of wavelengths of about 480 nm to about the 700 nm.

In a fourth simulated system 1230 in FIG. 12, the glass substrate with refractive index of 1.7 further comprises block-shaped nanometer-sized structures with refractive indices of also 1.7 on the opposite side of the interface from the incident light. A medium with refractive index of 1 is in contact on one side of the glass substrate comprising the nanometer sized structures. The nanostructures are the same as structures 1220 with equal length and width of 250 nm. In this instance, the structures 1230 have decreased height of only 200 nm compared to 250 nm for structures 1220. The spacing of structures 1230 is the same as structures 1220 of 250 nm and also arranged in the same checkerboard-like fashion. The resulting reflectance data is shown by dashed line 1230 in FIG. 12. Structures 1230 that are about 50 nm shorter in height exhibit a decrease in % reflectance over the same wavelength range when compared to structures 1220.

The following exemplary and non-limiting embodiments provide various implementations of the disclosure. Example 1 relates to a display front sheet, comprising: a transparent layer having a first surface and a second surface, the second surface positioned opposite the first surface, the second surface having a plurality of convex protrusions extending away from the first surface at least one protrusion having a dark pupil region; and structures positioned on the surface of the convex protrusions, the structures protruding away from a second surface of the transparent layer.

Example 2 is directed to the display front sheet of example 1, further comprising an electrode layer conformally disposed over the second surface of the transparent layer.

Example 3 is directed to the display front sheet of any preceding example, further comprising a dielectric layer conformally disposed over the electrode layer.

Example 4 is directed to the display front sheet of any preceding example, wherein at least one of the structures has a width of substantially equal or less than an incident light's wavelength.

Example 5 is directed to the display front sheet of any preceding example, wherein the structures are separated by a distance of substantially equal or less than an incident light's wavelength.

Example 6 is directed to the display front sheet of any preceding example, wherein one of the plurality of the convex protrusions extending away from the first surface defines a hemisphere.

Example 7 is directed to a reflective image display, comprising: a transparent layer having a first surface and a second surface, the second surface positioned opposite the first surface and the second surface having a plurality of convex protrusions extending away from the first surface, at least one protrusion having a dark pupil region; structures positioned on the surface of the convex protrusions, the structures protruding away from a second surface of the transparent layer; a substantially transparent front electrode layer positioned over the transparent layer; a dielectric layer disposed over the front electrode layer; a rear electrode positioned across the dielectric layer and forming a gap therebetween; and a plurality of electrophoretically mobile particles disposed in the gap.

Example 8 is directed to the reflective image display of example 7, wherein the front electrode is conformally disposed over the structures of the transparent layer.

Example 9 is directed to the reflective image display of any preceding example, wherein the dielectric layer is conformally disposed over the front electrode.

Example 10 is directed to the reflective image display of any preceding example, wherein at least one of the structures has a width of substantially equal or less than an incident light's wavelength.

Example 11 is directed to the reflective image display of any preceding example, wherein the structures are separated by a distance of substantially equal or less than an incident light's wavelength.

Example 12 is directed to the reflective image display of any preceding example, wherein one of the plurality of the convex protrusions extending away from the first surface defines a hemisphere.

Example 13 is directed to the reflective image display of any preceding example, wherein at least some of the electrophoretically mobile particles moves toward the front electrode when one or more of the front electrode or the rear electrode is biased.

Example 14 is directed a method to operate a reflective image display, the method comprising: conformally overlaying a front electrode over a transparent layer, the transparent layer having a plurality of protrusions, at least one protrusion further comprises a plurality of structures positioned thereon; positioning a rear electrode across from the dielectric layer to form a gap between the rear electrode and the dielectric layer; suspending a plurality of electrophoretically mobile particles in the gap formed between the dielectric layer and the rear electrode; and biasing the front electrode relative to the rear electrode at a first level to attract at least some of the plurality of electrophoretically mobile particles toward the front electrode.

Example 15 is directed to the method of example 14, further comprising biasing the front electrode relative to the rear electrode at a second level to attract at least some of the plurality of electrophoretically mobile particles toward the rear electrode.

Example 16 is directed to the method of any preceding example, further comprising conformally overlaying a dielectric layer over the front electrode.

Example 17 is directed to the method of any preceding example, wherein at least one of the structures has a width of substantially equal or less than an incident light's wavelength.

Example 18 is directed to the method of any preceding example, wherein the structures are separated by a distance of substantially equal or less than an incident light's wavelength.

Example 19 is directed to the method of any preceding example, wherein one of the plurality of the protrusions defines a hemisphere.

While the principles of the disclosure have been illustrated in relation to the exemplary embodiments shown herein, the principles of the disclosure are not limited thereto and include any modification, variation or permutation thereof.

What is claimed is:

1. A display front sheet, comprising:
a transparent layer having a first surface and a second surface, the second surface positioned opposite the first surface, the second surface having a plurality of convex protrusions extending away from the first surface at least one protrusion having a dark pupil region; and
structures positioned on the surface of the convex protrusions, the structures protruding away from a second surface of the transparent layer.

2. The display front sheet of claim 1, further comprising an electrode layer conformally disposed over the second surface of the transparent layer.

3. The display front sheet of claim 1, further comprising a dielectric layer conformally disposed over the electrode layer.

4. The display front sheet of claim 1, wherein at least one of the structures has a width of substantially equal or less than an incident light's wavelength.

5. The display front sheet of claim 1, wherein the structures are separated by a distance of substantially equal or less than an incident light's wavelength.

6. The display front sheet of claim 1, wherein one of the plurality of the convex protrusions extending away from the first surface defines a hemisphere.

7. A reflective image display, comprising:
a transparent layer having a first surface and a second surface, the second surface positioned opposite the first surface and the second surface having a plurality of convex protrusions extending away from the first surface, at least one protrusion having a dark pupil region;
structures positioned on the surface of the convex protrusions, the structures protruding away from a second surface of the transparent layer;
a substantially transparent front electrode layer positioned over the transparent layer;
a dielectric layer disposed over the front electrode layer;
a rear electrode positioned across the dielectric layer and forming a gap therebetween; and
a plurality of electrophoretically mobile particles disposed in the gap.

8. The reflective image display of claim 7, wherein the front electrode is conformally disposed over the structures of the transparent layer.

9. The reflective image display of claim 7, wherein the dielectric layer is conformally disposed over the front electrode.

10. The reflective image display of claim 7, wherein at least one of the structures has a width of substantially equal or less than an incident light's wavelength.

11. The reflective image display of claim 7, wherein the structures are separated by a distance of substantially equal or less than an incident light's wavelength.

12. The reflective image display of claim 7, wherein one of the plurality of the convex protrusions extending away from the first surface defines a hemisphere.

13. The reflective image display of claim 7, wherein at least some of the electrophoretically mobile particles moves toward the front electrode when one or more of the front electrode or the rear electrode is biased.

14. A method to operate a reflective image display, the method comprising:
conformally overlaying a front electrode over a transparent layer, the transparent layer having a plurality of protrusions, at least one protrusion further comprises a plurality of structures positioned thereon;
positioning a rear electrode across from the dielectric layer to form a gap between the rear electrode and the dielectric layer;
suspending a plurality of electrophoretically mobile particles in the gap formed between the dielectric layer and the rear electrode; and
biasing the front electrode relative to the rear electrode at a first level to attract at least some of the plurality of electrophoretically mobile particles toward the front electrode.

15. The method of claim 14, further comprising biasing the front electrode relative to the rear electrode at a second level to attract at least some of the plurality of electrophoretically mobile particles toward the rear electrode.

16. The method of claim 14, further comprising conformally overlaying a dielectric layer over the front electrode.

17. The method of claim 14, wherein at least one of the structures has a width of substantially equal or less than an incident light's wavelength.

18. The method of claim 14, wherein the structures are separated by a distance of substantially equal or less than an incident light's wavelength.

19. The method of claim 14, wherein one of the plurality of the protrusions defines a hemisphere.
